(19) United States
(12) Patent Application Publication
(10) Pub. No.: US 2016/0023333 A1
(43) Pub. Date: Jan. 28, 2016

(54) Tool Head with a Screw Positioning Sleeve

(71) Applicant: Jei Mou Industrial Co., Ltd., Taichung City (TW)

(72) Inventor: Bo-Shen Chen, Taichung City (TW)

(73) Assignee: Jei Mou Industrial Co., Ltd.

(21) Appl. No.: 14/340,118

(22) Filed: Jul. 24, 2014

(51) Int. Cl. B25B 23/10

(52) U.S. Cl. CPC B25B 23/10

(57) ABSTRACT

A tool head with a screw positioning sleeve includes a rod, a magnetic member, and an elastic member. The rod includes a connecting portion, a work portion, a shaft portion, and an annular positioning groove. The annular positioning groove includes a first annular abutting surface and an opposite second annular abutting surface. The screw positioning sleeve is slidably sleeved onto the rod and includes a first end surface located toward the work portion, a second end surface, a through hole for insertion of the rod. An abutting portion is formed in the through hole and located between the first and second annular abutting surfaces. A magnetic member is fixed to the screw positioning sleeve and located at the first end surface; and an elastic member is sleeved onto the shaft portion and pressed against the second annular abutting surface and the second end surface.

### BACKGROUND OF THE INVENTION

1. Field of the Invention

The present invention relates to a tool head, and more particularly to a tool head with a screw positioning sleeve.

2. Description of the Prior Art

A tool head normally comprises a connecting portion, a work head, and a shaft portion connected between the connecting portion and the work head. The connecting portion is connected to a hand tool or an electric tool directly or indirectly by a connecting rod to enable the work head to screw or unscrew a screw.

As shown in FIG. 1, a screw positioning sleeve 13 is used to position a screw 12 and prevent it from falling off when a tool head 11 screws or unscrews the screw 12. The tool head 11 is used in combination with a connecting rod 14 which is equipped with the screw positioning sleeve 13. The connecting rod 14 has a work end 141 inserted in a slide hole 131 of the screw positioning sleeve 13, at another end 132 of the screw positioning sleeve 13 is disposed a magnetic member 15, the screw positioning sleeve 13 is positioned and located at an axial distance to the work end 141 of the connecting rod 14, and the magnetic member 15 is used to attract the screw 12.

To prevent the screw 12 from falling off during screwing or unscrewing process, the tool head 11 has to be assembled to the connecting rod 14, and the connecting rod 14 also has to be assembled to the hand tool 16 (electric tool), namely, it requires two times assembling. Therefore, the assembling operation is troublesome, and the structure of the tool head is also complicated.

The present invention has arisen to mitigate and/or obviate the afore-described disadvantages.

### SUMMARY OF THE INVENTION

The primary objective of the present invention is to provide a tool head with a screw positioning sleeve, which only requires one assembling step to enable the tool head to stably attract and position the screw before screwing and unscrewing operation.

To achieve the above objective, a tool head with a screw positioning sleeve in accordance with the present invention comprises: a rod with a connecting portion, a work portion, a shaft portion connected between the connecting portion and the work portion, and an annular positioning groove formed on the shaft portion, the annular positioning groove including a first annular abutting surface and an opposite second annular abutting surface located closer to the connecting portion than the first annular abutting surface; a screw positioning sleeve slidably sleeved onto the rod and including a first end surface located toward the work portion, a second end surface, a through hole penetrating the first and second end surfaces, and provided for insertion of the rod, and an abutting portion formed in the through hole and located between the first and second annular abutting surfaces; a magnetic member fixed to the screw positioning sleeve and located at the first end surface; and an elastic member sleeved onto the shaft portion and including a first end abutted against the second annular abutting surface, and a second end abutted against the second end surface.

Preferably, the screw positioning sleeve further includes plural slots extending from the second end surface toward the first end surface.

Preferably, the screw positioning sleeve further includes an engaging portion recessed from the first end surface toward the second end surface, and the magnetic member is engaged in the engaging portion.

To achieve the above objective, a tool head with a screw positioning sleeve in accordance with the present invention comprises: a rod with a connecting portion, a work portion, a shaft portion connected between the connecting portion and the work portion, and an annular positioning rib formed on the shaft portion, the annular positioning rib including a first annular abutting surface and an opposite second annular abutting surface located closer to the work portion than the first annular abutting surface; a screw positioning sleeve slidably sleeved onto the rod and including a first end surface located toward the work portion, a second end surface, a through hole penetrating the first and second end surfaces, and provided for insertion of the rod, a first abutting portion formed in the through hole and located toward the first annular abutting surfaces, and a second abutting portion formed in the through hole and located toward the second annular abutting surfaces; a magnetic member fixed to the screw positioning sleeve and located at the first end surface; and an elastic member sleeved onto the shaft portion and including a first end abutted against the second annular abutting surface, and a second end abutted against the second end surface.

Preferably, the screw positioning sleeve further includes plural slots extending from the second end surface toward the first end surface.

Preferably, the screw positioning sleeve further includes an engaging portion recessed from the first end surface toward the second end surface, and the magnetic member is engaged in the engaging portion.

### BRIEF DESCRIPTION OF THE DRAWINGS

FIG. 1 is an illustrative view showing a tool head with a conventional screw positioning sleeve;

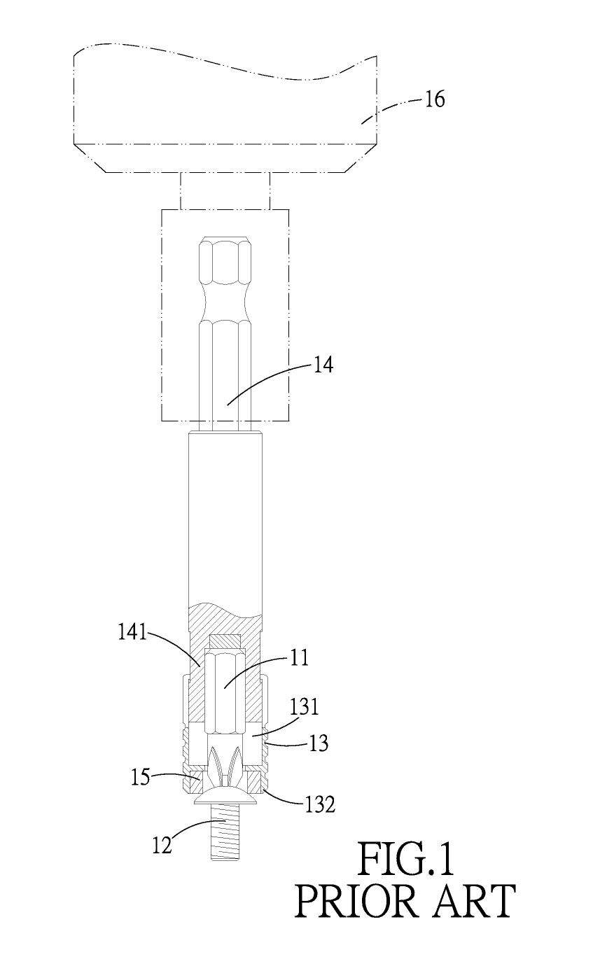

FIG. 2 is an exploded view of a tool head with a screw positioning sleeve in accordance with a first embodiment of the present invention;

FIG. 3 is an assembly view of the tool head with the screw positioning sleeve in accordance with the first embodiment of the present invention;

FIG. 4 is a cross sectional view of the tool head with the screw positioning sleeve in accordance with the first embodiment of the present invention;

FIG. 5 is an operational view of the tool head with the screw positioning sleeve in accordance with the first embodiment of the present invention;

FIG. 6 is an exploded view of a tool head with a screw positioning sleeve in accordance with a second embodiment of the present invention;

FIG. 7 is an assembly view of the tool head with the screw positioning sleeve in accordance with the second embodiment of the present invention;

FIG. 8 is a cross sectional view of the tool head with the screw positioning sleeve in accordance with the second embodiment of the present invention; and

FIG. 9 is an operational view of the tool head with the screw positioning sleeve in accordance with the second embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

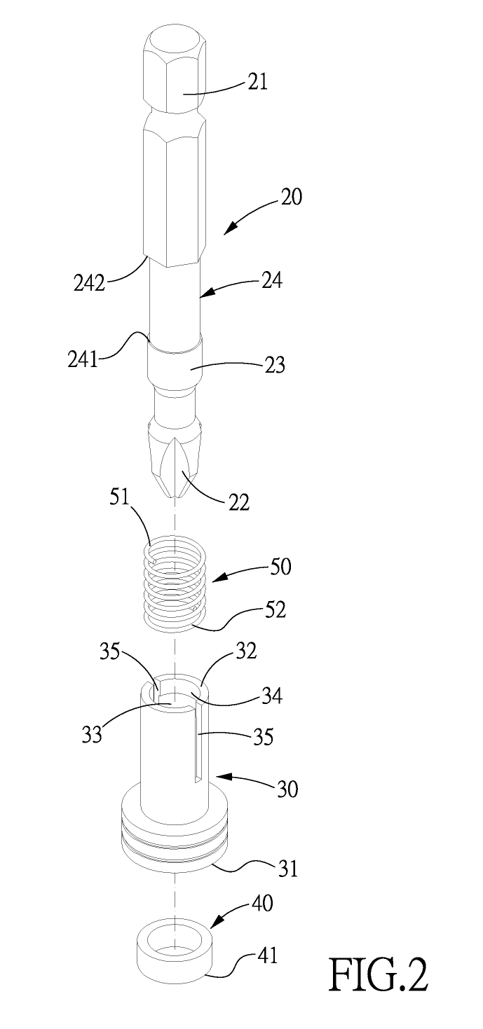

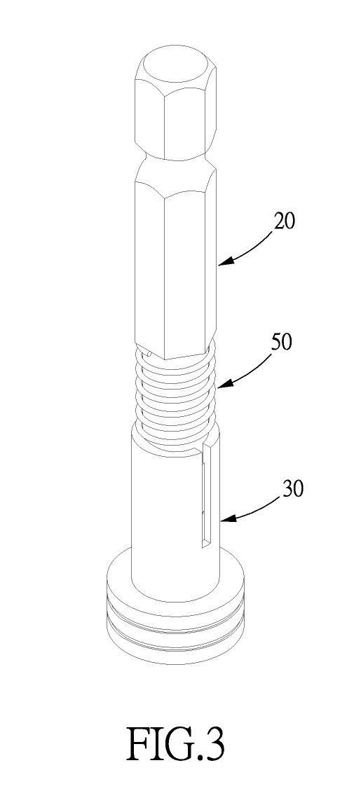

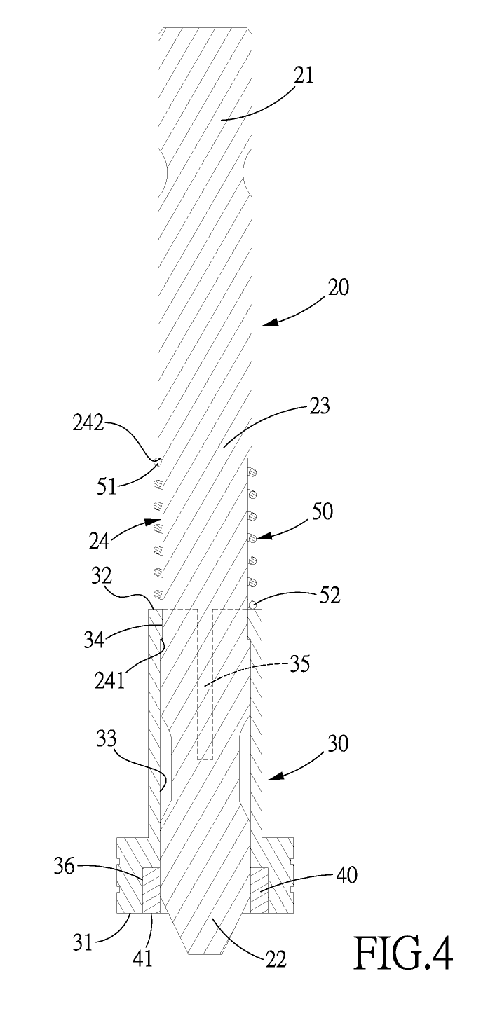

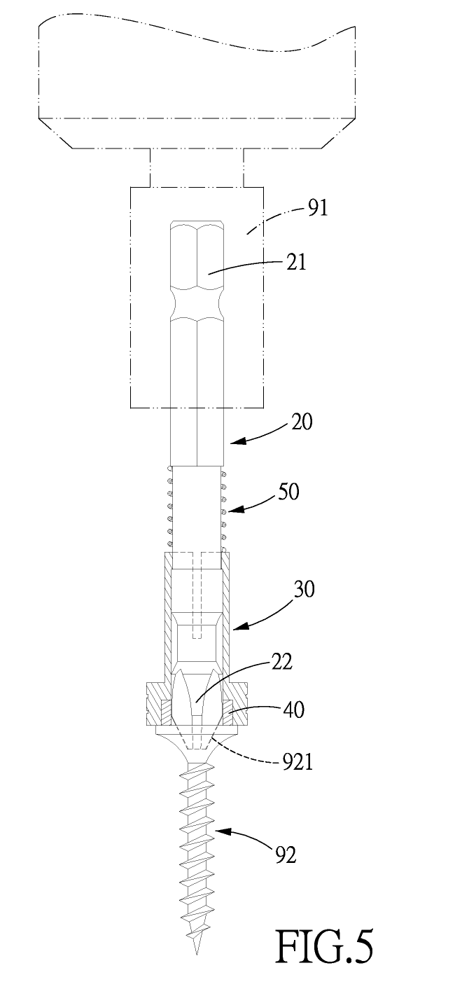

Referring to FIGS. 2-5, a tool head with a screw positioning sleeve in accordance with a first embodiment of the present invention comprises: a rod 20, the screw positioning sleeve 30, a magnetic member 40, and an elastic member 50.

The rod 20 includes a connecting portion 21 for connecting to a hand tool 91 (or electric tool), a work portion 22 for rotating a screw 92, a shaft portion 23 connected between the connecting portion 21 and the work portion 22, and an annular positioning groove 24 formed on the shaft portion 23. The annular positioning groove 24 includes a first annular abutting surface 241 and an opposite second annular abutting surface 242 located closer to the connecting portion 21 than the first annular abutting surface 241.

The screw positioning sleeve 30 is slidably sleeved onto the rod 20 and includes a first end surface 31 located toward the work portion 22, a second end surface 32, a through hole 33 penetrating the first and second end surfaces 31, 32 and provided for insertion of the rod 20, and an abutting portion 34 formed in the through hole 33 and located between the first and second annular abutting surfaces 241, 242. In this embodiment, the screw positioning sleeve 30 further includes two slots 35 extending from the second end surface 32 toward the first end surface 31, so that the screw positioning sleeve 30 would have certain flexibility for easy insertion of the rod 20. The screw positioning sleeve 30 further includes an engaging portion 36 recessed from the first end surface 31 toward the second end surface 32.

The magnetic member 40 is fixed to the screw positioning sleeve 30 and located at the first end surface 31. In this embodiment, the magnetic member 40 is engaged in the engaging portion 36 and has a magnetic surface 41 flushed with the first end surface 31. The magnetic member 40 is an annular magnet which is located adjacent to and provided for insertion of the work portion 22.

The elastic member 50 is sleeved onto the shaft portion 23 and includes a first end 51 abutted against the second annular abutting surface 242, and a second end 52 abutted against the second end surface 32, so as to make the abutting portion 34 of the screw positioning sleeve 30 keep abutting against the first annular abutting surface 241 of the rod 20, and keep the magnetic member 40 at a position adjacent to the work portion 22 of the rod 20. In this embodiment, the elastic member 50 is a compression spring.

What mentioned above are the structures of the first preferred embodiment of the present invention, for a better understanding of the invention, its operating advantages and the specific objects attained by its uses, reference should be had to the following descriptive matter.

The work portion 22 of the rod 20 will be able to rotate the screw 92 simply by connecting the connecting portion 21 of the rod 20 directly to a hand tool 91 (or electric tool). Besides, the screw positioning sleeve 30 is directly sleeved onto the rod 20 and provided with the magnetic member 40, and the elastic member 50 keeps the magnetic member 40 staying in a position adjacent to the work portion 22 of the rod 20. Therefore, the screw 92 can be attracted against the screw positioning sleeve 30 while being rotated. Meanwhile, the work portion 22 of the rod 20 is engaged with the engaging recess 921 of the screw 92 to prevent disengagement of the screw 92 from the tool head during screwing or unscrewing operation.

It just takes one step (one time assembling) to assemble the tool head with the screw positioning sleeve to the hand tool or electric tool, so as to enable the tool head to stably attract and position the screw 92 before screwing and unscrewing operation. Namely, the assembling operation of the tool head with the screw positioning sleeve in accordance with the present invention is convenient, and the structure of the tool head is also simplified.

It is to be noted that the elastic member 50 makes the abutting portion 34 of the screw positioning sleeve 30 keep abutting against the first annular abutting surface 241 of the rod 20, and keeps the magnetic member 40 at a position adjacent to the work portion 22 of the rod 20. Therefore, once the work portion 22 of the rod 20 is engaged with the screw 92, the screw positioning sleeve 30 can be used in combination with the magnetic member 40 to position the screw 92, no matter in whichever direction the screwing or unscrewing operation is carried out.

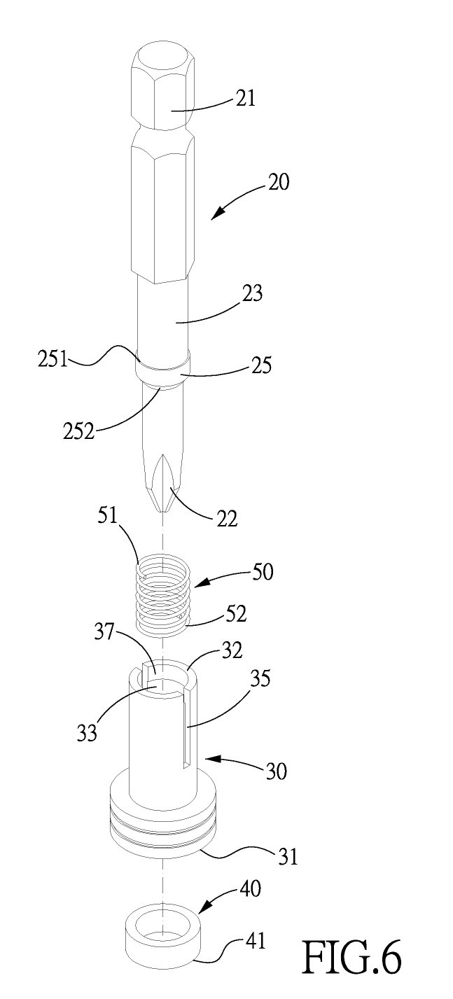

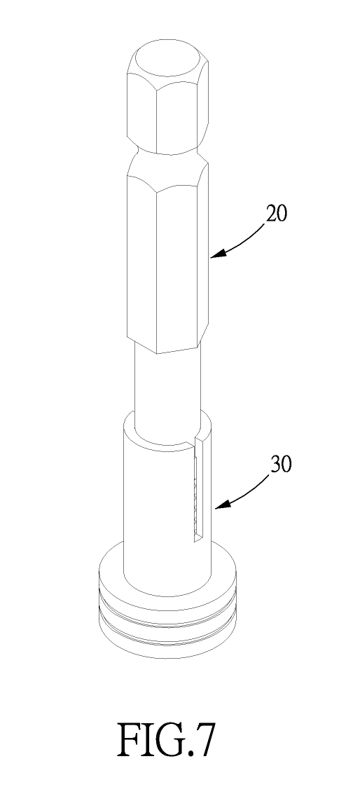

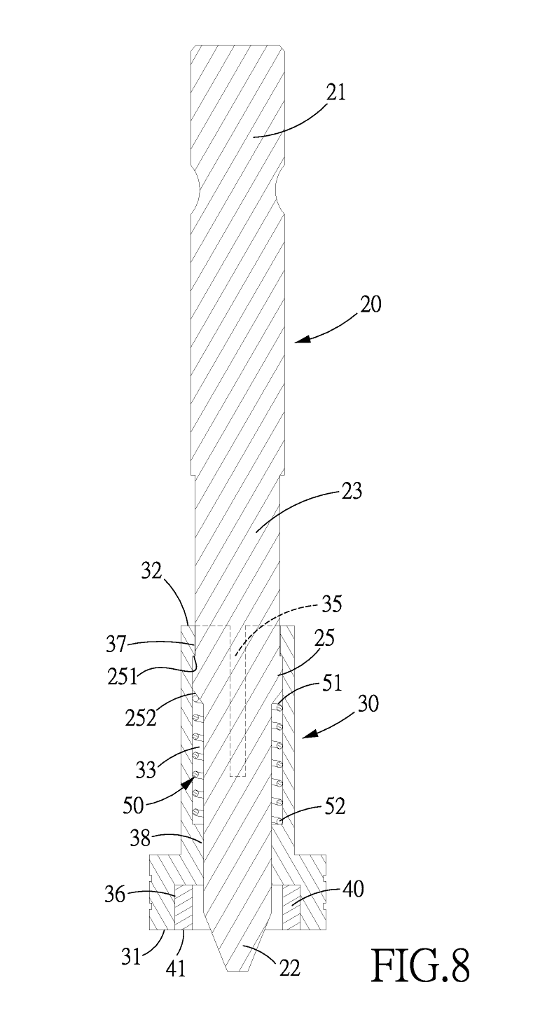

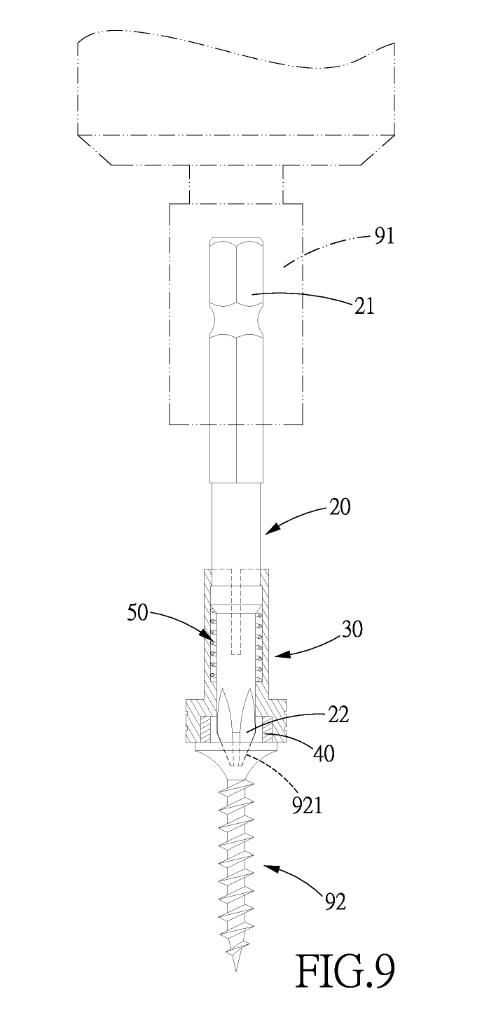

Referring then to FIGS. 6-9, a tool head with a screw positioning sleeve in accordance with a second embodiment of the present invention comprises: a rod 20, the screw positioning sleeve 30, a magnetic member 40, and an elastic member 50.

The rod 20 includes a connecting portion 21 for connecting to a hand tool 91 (or electric tool), a work portion 22 for rotating a screw 92, a shaft portion 23 connected between the connecting portion 21 and the work portion 22, and an annular positioning rib 25 formed on the shaft portion 23. The annular positioning rib 25 includes a first annular abutting surface 251 and an opposite second annular abutting surface 252 located closer to the work portion 22 than the first annular abutting surface 241.

The screw positioning sleeve 30 is slidably sleeved onto the rod 20 and includes a first end surface 31 located toward the work portion 22, a second end surface 32, a through hole 33 penetrating the first and second end surfaces 31, 32 and provided for insertion of the rod 20, a first abutting portion 37 formed in the through hole 33 and located toward the first annular abutting surfaces 251, and a second abutting portion 38 formed in the through hole 33 and located toward the second annular abutting surfaces 252. In this embodiment, the screw positioning sleeve 30 further includes two slots 35 extending from the second end surface 32 toward the first end surface 31, so that the screw positioning sleeve 30 would have certain flexibility for easy insertion of the rod 20. The screw positioning sleeve 30 further includes an engaging portion 36 recessed from the first end surface 31 toward the second end surface 32.

The magnetic member 40 is fixed to the screw positioning sleeve 30 and located at the first end surface 31. In this embodiment, the magnetic member 40 is engaged in the engaging portion 36 and has a magnetic surface 41 flushed with the first end surface 31. The magnetic member 40 is an annular magnet which is located adjacent to and provided for insertion of the work portion 22.

The elastic member 50 is sleeved onto the shaft portion 23 and includes a first end 51 abutted against the second annular abutting surface 242, and a second end 52 abutted against the second end surface 32, so as to make the abutting portion 34 of the screw positioning sleeve 30 keep abutting against the first annular abutting surface 251 of the rod 20, and keep the magnetic member 40 at a position adjacent to the work portion 22 of the rod 20. In this embodiment, the elastic member 50 is a compression spring.

This embodiment also just requires one time assembling to enable the tool head to stably attract and position the screw 92 before screwing and unscrewing operation.

While we have shown and described various embodiments in accordance with the present invention, it is clear to those skilled in the art that further embodiments may be made without departing from the scope of the present invention.

What is claimed is:

1. A tool head with a screw positioning sleeve comprising:
a rod with a connecting portion, a work portion, a shaft portion connected between the connecting portion and the work portion, and an annular positioning groove formed on the shaft portion, the annular positioning groove including a first annular abutting surface and an opposite second annular abutting surface located closer to the connecting portion than the first annular abutting surface;
a screw positioning sleeve slidably sleeved onto the rod and including a first end surface located toward the work portion, a second end surface, a through hole penetrating the first and second end surfaces, and provided for insertion of the rod, and an abutting portion formed in the through hole and located between the first and second annular abutting surfaces;
a magnetic member fixed to the screw positioning sleeve and located at the first end surface; and
an elastic member sleeved onto the shaft portion and including a first end abutted against the second annular abutting surface, and a second end abutted against the second end surface.

2. The tool head with a screw positioning sleeve as claimed in claim 1, wherein the screw positioning sleeve further includes plural slots extending from the second end surface toward the first end surface.

3. The tool head with a screw positioning sleeve as claimed in claim 1, wherein the screw positioning sleeve further includes an engaging portion recessed from the first end surface toward the second end surface, and the magnetic member is engaged in the engaging portion.

4. A tool head with a screw positioning sleeve comprising:
a rod with a connecting portion, a work portion, a shaft portion connected between the connecting portion and the work portion, and an annular positioning rib formed on the shaft portion, the annular positioning rib including a first annular abutting surface and an opposite second annular abutting surface located closer to the work portion than the first annular abutting surface;
a screw positioning sleeve slidably sleeved onto the rod and including a first end surface located toward the work portion, a second end surface, a through hole penetrating the first and second end surfaces, and provided for insertion of the rod, a first abutting portion formed in the through hole and located toward the first annular abutting surfaces, and a second abutting portion formed in the through hole and located toward the second annular abutting surfaces;
a magnetic member fixed to the screw positioning sleeve and located at the first end surface; and
an elastic member sleeved onto the shaft portion and including a first end abutted against the second annular abutting surface, and a second end abutted against the second end surface.

5. The tool head with a screw positioning sleeve as claimed in claim 4, wherein the screw positioning sleeve further includes plural slots extending from the second end surface toward the first end surface.

6. The tool head with a screw positioning sleeve as claimed in claim 4, wherein the screw positioning sleeve further includes an engaging portion recessed from the first end surface toward the second end surface, and the magnetic member is engaged in the engaging portion.
